(19) United States
(12) Patent Application Publication
(10) Pub. No.: US 2015/0069867 A1
(43) Pub. Date: Mar. 12, 2015

(54) ELECTRIC MACHINE AND METHOD FOR REWINDING IT

(71) Applicant: ALSTOM Technology Ltd, Baden (CH)

(72) Inventors: Denis Thiot, Belfort (FR); Paul Lapotre, Egreville (FR)

(21) Appl. No.: 14/541,787

(22) Filed: Nov. 14, 2014

Related U.S. Application Data
(63) Continuation of application No. PCT/EP2013/059736, filed on May 10, 2013.

(30) Foreign Application Priority Data
May 16, 2012 (EP) 12290167.1

(51) Int. Cl. H02K 9/00; H02K 15/06; H02K 15/02

(52) U.S. Cl. CPC H02K 9/005; H02K 15/024; H02K 15/063
USPC 310/59; 29/598

(57) ABSTRACT

The method for rewinding and electric machine includes removing the original stator bars from the slots, removing the original supports from the slots, and providing new supports into the slots, wherein the new supports defining cooling channels that extend over at least a portion of the slot, providing new stator bars into the slots.

### CROSS-REFERENCE TO RELATED APPLICATIONS

This application claims priority to PCT/EP2013/059736 filed May 10, 2013, which claims priority to European application 12290167.1 filed May 16, 2012, both of which are hereby incorporated in their entireties.

### TECHNICAL FIELD

The present disclosure relates to an electric machine and a method for rewinding it.

The electric machine can be a rotating electric machine such as a synchronous generator to be connected to a gas or steam turbine (turbogenerator) or a synchronous generator to be connected to a hydro turbine (hydro generator) or an asynchronous generator or a synchronous or asynchronous electric motor or also other types of electric machines.

### BACKGROUND

FIG. 1 shows an electric machine 1 such as an electric generator that includes a stator 2 and a rotor 3.

The stator 2 has an annular configuration defining a central bore 4 and has stator slots 5 opening in the stator bore 4. At the bottom of the slots 5 there are provided supports 6 that support stator bars 7 (usually one or often two stator bars one above the other); the slots 5 are thus closed by wedges 8. The stator bars 7 are connected together and define a stator winding.

Periodically, the electric machine 1 undergoes outages and maintenance operations that can include a rewinding.

Rewinding includes removal of the stator bars and replacement with new stator bars.

Traditionally, the new stator bars are chosen such that the losses that they cause are almost the same as the losses caused by the original stator bars or a little bit smaller thereof.

In addition, the new stator bars usually have better performances than the original bars and thus cause lower specific losses than the original stator bars (specific losses meaning losses for the unitary cross section); for example this can be due to a better Roebelisation or to an increased number of thinner strands, or to a reduction of the insulation thickness in favour of the copper section.

Since the new stator bars have less specific losses than the original bars, and since the total losses of the new stator bars is desired to be lower than or equal to the losses of the original stator bars, the new stator bars are often manufactured with a smaller cross section than the original stator bars.

The same occurs in case the cooling fluid is changed, such that the new cooling fluid of the new stator bars can draw a higher heat amount (due to the losses) than the original fluid used with the original stator bars. For example, the new stator bars could be water cooled, whereas the original stator bars were gas cooled. Also in these cases, the cross section of the new stator bars is often smaller than the cross section of the original stator bars.

In these cases, since the new stator bar cross section is smaller than the original stator bar cross section, the new stator bars occupy less space in the slots.

In order to fill in the whole space in the slots, usually the supports 6 are replaced with larger supports that fill in the whole space at the bottom of the slots 5.

In addition, it is known that the stator 2 is realised by a plurality of laminations slightly insulated from one another. During operation or also during maintenance operation the insulation between adjacent laminations can be damaged, such that two or even more laminations are short circuited.

Short circuited laminations cause local circulation of idle currents that cause high losses and hot spots in the stator.

In addition, there could also be “design hot spots”, i.e. small location showing a higher temperature than the average temperature; for example these could be due to local losses concentration (for example axial caused by the field at the core ends).

Hot spots can be troubling for the stator, because they can cause further damage of the insulation between adjacent laminations, edging of the stator and also melting of the laminations.

For these reasons, hot spots must be counteracted.

### SUMMARY

An aspect of the disclosure includes providing a method and an electric machine that permit to counteract the degradation of the stator at zones close to the hot spots.

Advantageously, in order to counteract the operating limits of the stator core due to hotspots, the space made available after replacement of the original stator bars with the new stator bars is used.

These and further aspects are attained by providing an electric machine and a method in accordance with the accompanying claims.

### BRIEF DESCRIPTION OF THE DRAWINGS

Further characteristics and advantages will be more apparent from the description of a preferred but non-exclusive embodiment of the method and electric machine, illustrated by way of non-limiting example in the accompanying drawings, in which:

FIG. 1 is a schematic view of an electric machine such as an electric generator;

FIG. 2 is a schematic view of a slot that houses stator bars according to the prior art;

FIGS. 3, 4, 5 are schematic views of a slot that houses stator bars in different embodiments of the disclosure;

FIG. 6 is a schematic view of a different electric machine such as an electric generator with stator having radial cooling;

FIG. 7 is a schematic longitudinal section of a slot;

FIG. 8 is a schematic view cross section of the slot of FIG. 7;

FIG. 9 shows an embodiment of a support; and

FIG. 10 shows a further embodiment of an electric machine with radial cooling.

### DETAILED DESCRIPTION

Electric Machine

In the following the electric machine is described first and the same references define the same or similar components throughout the several figures.

The electric machine 1 comprises the stator 2 and the rotor 3.

The stator 2 has a plurality of axial slots 5. Each axial slot 5 houses a support 6 (but they can also be more than one) at its bottom.

The support 6 supports stator bars 7 (usually two stator bars 7 one on top of the other, any number of stator bars is anyhow possible). The slot 5 is thus closed by the wedge 8.

The support 6 defines one or more cooling channels 10 that extend over at least a portion of the slot 5.

The support 6 can be defined by elements that run over the whole axial length of the slots 5.

Preferably, each cooling channel 10 is partly defined by a slot surface 18; this helps heat transfer and thus cooling of the stator laminations.

The channels 10 can open outside the slots 5 at the axial opposite ends 17 of the stator 2 (i.e. at the opposite longitudinal ends of the slots 5).

In addition, the support 6 housed in each slot 5 can define a plurality of channels 10. This also can help heat transfer and thus cooling of the stator laminations.

If the stator has radial cooling channels 13, the supports 6 are provided at the radial cooling channels 13; this prevents mixing of the flow through the radial channels 13 and cooling channels 10.

For example, the supports can be defined by elements that run over only a portion of the slots 5; thus each slot 5 houses a plurality of these elements.

In addition, the supports 6 can also be defined by elements that run over a length of the slots 5 intersecting at least two radial cooling channels 13. These elements have protruding portions 15 that are provided at the radial cooling channels 13. The protruding portions 15 define the cooling channels 10.

In addition, the cooling channels 10 can open at the radial cooling channels 13 and/or at one or both of the opposite ends 17 of the stator 2 (i.e. at the opposite ends of the slots 5).

In the following three specific examples are described in detail.

### EXAMPLE 1

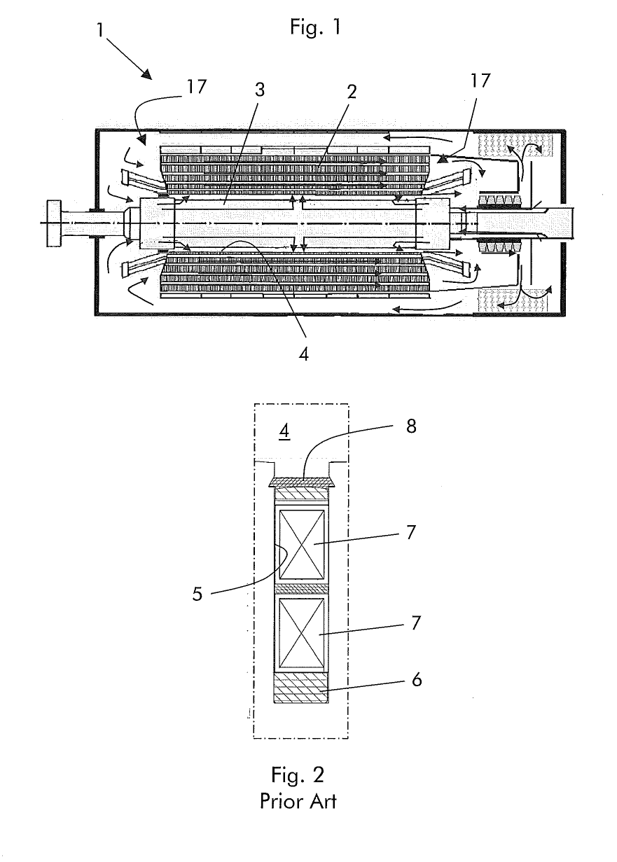

### (FIG. 1, 3, 4, 5)

In this first example the electric machine has a stator like the one shown in FIG. 1, with axial cooling channels 10.

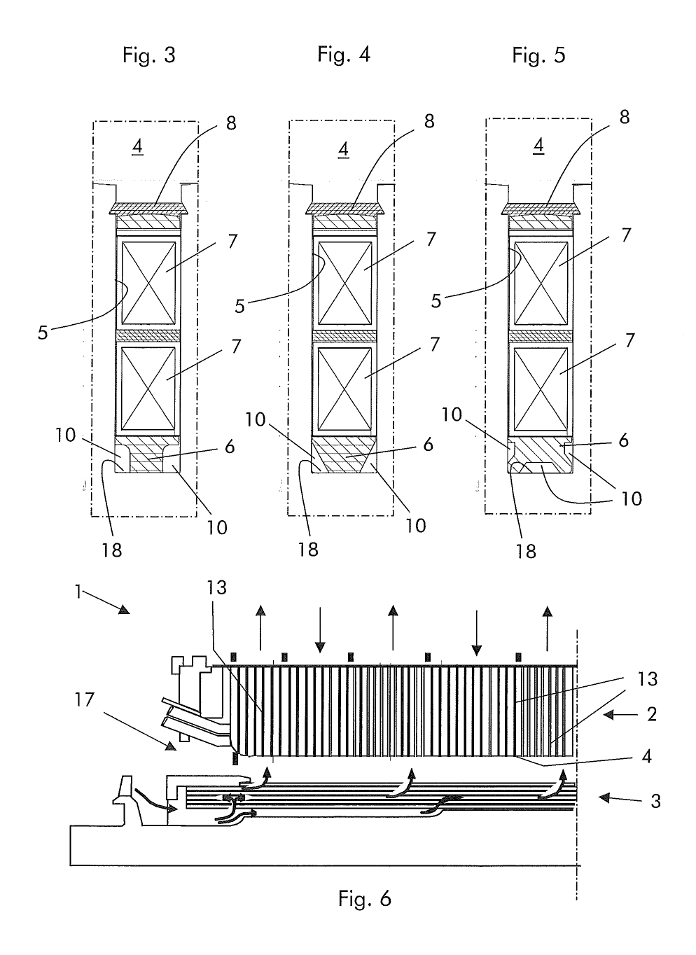

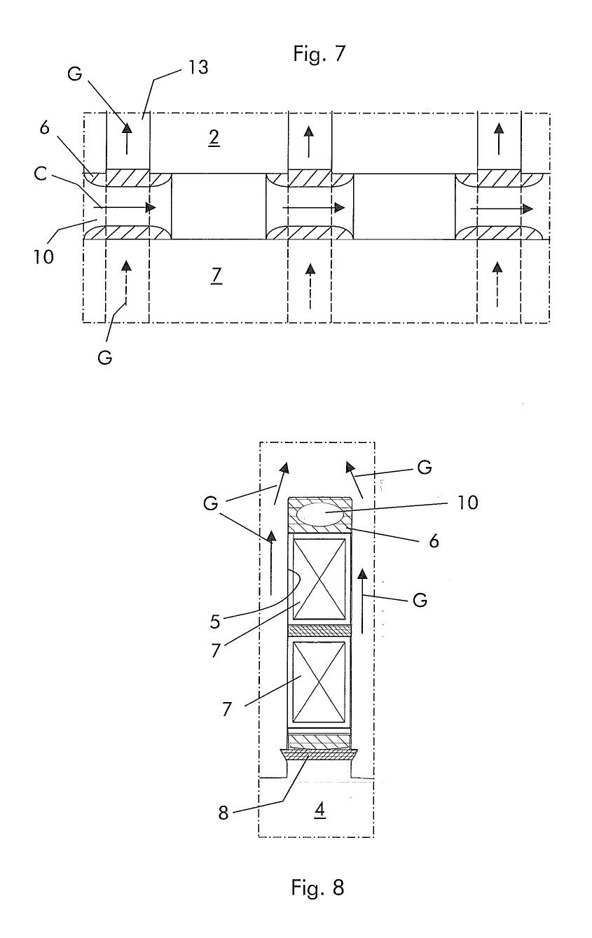

The slots 5 of this electric machine can have the features shown in FIGS. 3 through 5.

These slots 5 open at the opposite ends 17 of the stator 2 and house a support 6 each.

The supports 6 can define one channel 10 that can be partly defined by the slot surface 18 or not. Preferably the supports 6 define more than one channel 10 in each slot 5 (for example two, three or more) together with the slot surface 18.

The part of the support 6 that faces the stator bars 7 preferably extends over the whole slot width to guarantee a reliable support of the stator bars 7.

During operation cooling fluid enters the slot at one end 17, passes though the channels 10 cooling the stator 2 (limiting the temperature of the hot spots) and move out of the slots 5 at the other stator end 17. In this embodiment cooling fluid circulation is guarantee by a compressor or fan driven by the main rotor.

### EXAMPLE 2

### (FIG. 6, 7, 8)

In the second example the electric machine has a stator with radial cooling channels 13. The slots 5 extend axially and house the stator bars 7 and a plurality of supports 6. The supports 6 are located at the radial cooling channels 13 and define the channels 10.

During operation, cooling fluid G enters the radial cooling channels 13 from the bore 4 and passes around the slots 5 and supports 6. At the same time cooling fluid C enters at one end 17 of the stator and passes through the slots 5 (at the bottom thereof) and moves out of the slots 5 at the other stator end 17. At the intersections between the radial cooling channels 13 and slots 5 the supports 6 are provided that define the channels 10. The cooling fluid C passes through the channels 10 such that it does not mix with the cooling fluid G.

### EXAMPLE 3

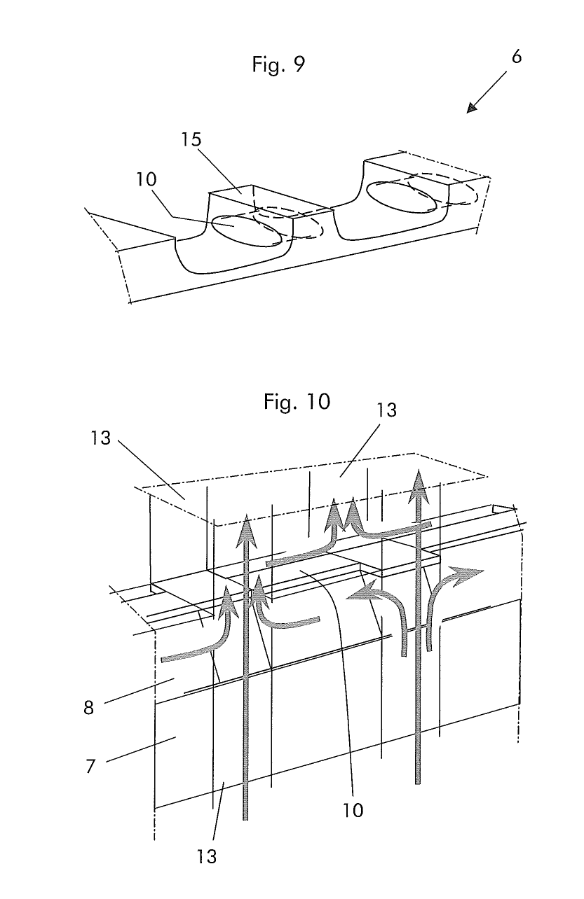

### (FIG. 9)

In this example the electric machine can have the same features as the one described in example 2.

The supports 6 in this embodiment are not defined by a plurality of component located at the radial channels 13. In contrast one single element is provided that runs over the whole slot length. This support 6 has the protrusions 15 that are located at the radial channels 13. The protrusions 15 define the channels 10.

The operation according to this embodiment is similar to the one described with reference to the embodiment of example 2.

### EXAMPLE 4

### (FIG. 10)

In a fourth example, the electric machine 1 has a rotor 3 with radial cooling channels 13. The slots 5 do not open at the opposite stator ends 17, but they are connected to the radial cooling channels 13, such that cooling fluid passes from a radial cooling channel 13 into the slots 5, passes through at least a portion of the slots 5 to than move out from the slots via another radial cooling channel 13 of the stator. Advantageously, the wedges 8 have an asymmetrical design, which is used to create small local pressure differences to ensure gas circulation between the radial ducts.

The cooling provided at the bottom of the slots 5 helps draining heat away from the stator 2. Thus even if hot spots in the stator exist, limits of the electric machine operation and further damage of the insulation between adjacent laminations, edging of the stator and melting of the laminations are counteracted.

Method

The present disclosure also refers to a method for rewinding and electric machine.

The method comprises:
removing the original stator bars from the slots 5
removing the original supports from the slots 5
providing new supports 6 into the slots 5, the new supports 6 defining cooling channels 10 that extends over at least a portion of the slot
providing new stator bars 7 into the slots 5.

Naturally the features described may be independently provided from one another.

In practice the materials used and the dimensions can be chosen at will according to requirements and to the state of the art.

1. An electric machine comprising a stator and a rotor, the stator having a plurality of axial slots, each axial slot housing at least a support at its bottom for at least a stator bar, wherein the at least a support defines at least a cooling channel that extends over at least a portion of the slot.

2. The electric machine according to claim 1, wherein the at least a support is defined by elements that run over the whole axial length of the slots.

3. The electric machine according to claim 1, wherein each cooling channel is partly defined by the slot surface.

4. The electric machine according to claim 1, wherein the cooling channels open outside the slots at the opposite ends of the stator.

5. The electric machine according to claim 1, wherein the at least a support housed in each slot defines a plurality of cooling channels.

6. The electric machine according to claim 1, wherein the stator has radial cooling channels, and the supports are provided at the radial cooling channels.

7. The electric machine according to claim 6, wherein the supports are defined by elements that run over only a portion of the slots, and in that each slot houses a plurality of elements.

8. The electric machine according to claim 6, wherein the supports are defined by elements that run over a length of the slots intersecting at least two radial cooling channels, in each element has protruding portions that are provided at the radial cooling channels, and the protruding portions define the cooling channels.

9. The electric machine according to claim 6, wherein the cooling channels open at radial cooling channels.

10. A method for rewinding and electric machine having a stator and a rotor, the stator having a plurality of axial slots, each axial slot housing at least an original support at its bottom for at least an original stator bar; the method comprising:
removing the original stator bars from the slots,
removing the original supports from the slots,
providing new supports into the slots, the new supports defining cooling channels that extends over at least a portion of the slot, and
providing new stator bars into the slots.
